(19) United States
(12) Patent Application Publication
(10) Pub. No.: US 2013/0077747 A1
(43) Pub. Date: Mar. 28, 2013

(54) X-RAY IMAGING APPARATUS AND METHOD OF CAPTURING IMAGES WITH SAME

(71) Applicant: CANON KABUSHIKI KAISHA, Tokyo (JP)

(72) Inventors: Takashi Kamono, Utsunomiya-shi (JP); Akira Miyake, Nasukarasuyama-shi (JP)

(73) Assignee: CANON KABUSHIKI KAISHA, Tokyo (JP)

(21) Appl. No.: 13/626,250

(22) Filed: Sep. 25, 2012

(30) Foreign Application Priority Data
Sep. 28, 2011 (JP) 2011-212968

(51) Int. Cl. G01N 23/04

(52) U.S. Cl. 378/62

(57) ABSTRACT

An image capturing apparatus includes a diffraction grating that diffracts radiation from an X-ray source to form an interference pattern, a detector that detects the radiation having passed through the diffraction grating, a shutter configured to be removably disposed between the X-ray source and an object to block the radiation from the X-ray source, and an adjustment mechanism that performs alignment of at least one of the X-ray source, the diffraction grating and the detector. When the shutter is disposed between the X-ray source and the object, the shutter defines a first space shielded from the radiation from the X-ray source and a second space not shielded from the radiation. The adjustment mechanism performs the alignment in accordance with at least part of an intensity distribution of the radiation having traveled through the second space and detected by the detector.

### BACKGROUND OF THE INVENTION

1. Field of the Invention

The present invention relates to X-ray imaging apparatuses using X-rays and a method of capturing X-ray images.

2. Description of the Related Art

Recently, an imaging technology known as X-ray phase contrast imaging has been studied as a tool for visualizing internal structures of soft tissue and small organisms. X-ray phase contrast imaging causes contrast to occur in accordance with changes of the phases of X-rays occurring when the X-rays transmit through an object of interest. An example of X-ray phase contrast imaging is an imaging method known as an X-ray Talbot interference method that utilizes Talbot interference.

An outline of Talbot interference is given below. In order to capture an image using the Talbot interference method, an X-ray imaging apparatus equipped with an X-ray source that emits spatially coherent X-rays, a diffraction grating that diffracts X-rays, and a detector that detects X-rays is required. The spatially coherent X-rays are diffracted by the diffraction grating, and an interference pattern (a self image) having a periodic pattern of bright and dark portions is formed at a specified position. This phenomenon is known as the Talbot effect. When an object is placed between the X-ray source and the diffraction grating, the phases of the X-rays emitted from the X-ray source are changed by the object. Thus, by detecting a self image formed by the X-rays, the phase of which has been changed after having been transmitted through the object, a phase image of the object can be obtained.

Since the period of the self image is small, a detector having a high spatial resolution or a shield grating is required in order to detect the self image.

The shield grating is a grating, in which shielding portions that block X-rays and transmitting portions that allow X-rays to transmit therethrough are periodically arranged. When the shield grating is disposed at a position at which the self image is formed, a Moire is formed by the self image and the shield grating superposed on each other. That is, with the shield grating, information about changes in the phases of the X-rays caused by the object can be detected by the detector as deformation of the Moire caused by the object.

In an imaging apparatus performing the X-ray Talbot interference method using the shield grating, when the shield grating is used, the shield grating is aligned so as to adjust the contrast of the self image or the Moire detected by the detector, or to reduce blurring.

Japanese Patent Laid-Open No. 2010-164373 discloses an imaging apparatus, in which X-rays that have not been transmitted through an object and have been transmitted through a diffraction grating and a shield grating are detected by a detector, and alignment is performed in accordance with a detection result.

In the imaging apparatus disclosed in Japanese Patent Laid-Open No. 2010-164373, since alignment is performed by irradiating the diffraction grating with X-rays while the object is placed in the imaging apparatus, the object is also irradiated with X-rays. Thus, the amount of X-ray radiation which the object is exposed to is increased compared to the case where alignment is not performed.

Japanese Patent Laid-Open No. 2010-164373 also discloses an imaging apparatus in which alignment is performed before the object is placed in the imaging apparatus. In this case, since the object is not irradiated with X-rays during alignment, the amount of X-ray radiation which the object is exposed to can be decreased compared to the case where alignment is performed while the object is being placed in the imaging apparatus. However, when alignment is performed using this method, deviations in alignment occurring during or after placement of the object in the imaging apparatus cannot be corrected.

### SUMMARY OF THE INVENTION

Accordingly, the exemplary embodiments of the present invention are directed to an X-ray imaging apparatus that advantageously decreases the amount of X-ray radiation with which an object is irradiated during alignment for imaging with the X-ray Talbot interference method, the imaging apparatus performing alignment after the object has been positioned for imaging with the imaging apparatus.

An X-ray imaging apparatus according to one aspect of the present invention includes a diffraction grating that diffracts an X-ray from an X-ray source so as to form an interference pattern having a bright portion and a dark portion arranged in the interference pattern, a detector that detects the X-ray having passed through the diffraction grating, a shutter configured to be removably disposed between the X-ray source and an object to temporarily block the X-ray from the X-ray source, and an adjustment mechanism configured to adjust either or both of positions of at least two of the X-ray source, the diffraction grating and the detector relative to each other, and an orientation of at least one of the X-ray source, the diffraction grating, and the detector with respect to an irradiation axis. In the X-ray imaging apparatus, when the shutter is disposed between the X-ray source and the object, the shutter defines a first space shielded from irradiation by the X-ray from the X-ray source, and a second space not shielded from the irradiation. In the X-ray imaging apparatus, the adjustment mechanism adjusts either or both of the positions and the orientation in accordance with at least part of an intensity distribution of the X-ray having traveled through the second space and being detected by the detector.

Further features and advantages will become apparent to persons having ordinary skill in the art from the following description of exemplary embodiments with reference to the attached drawings.

### BRIEF DESCRIPTION OF THE DRAWINGS

FIG. 1 is a schematic diagram of an X-ray imaging apparatus according to a first embodiment of the present invention.

FIG. 2 is a sectional view of a phase grating according to an embodiment of the present invention.

FIG. 3A is a schematic diagram of a shutter in a closed state seen from an X-ray source side.

FIG. 3B is a schematic diagram of a shutter in an open state seen from the X-ray source side.

FIG. 4 is a schematic diagram of a detector seen from the X-ray source side.

FIG. 5 is a schematic diagram of an X-ray imaging apparatus according to a second embodiment of the present invention.

FIG. 6A is a schematic diagram of a shielding wall structure according to the second embodiment of the present invention.

FIG. 6B is a schematic diagram of the shielding wall structure according to the second embodiment of the present invention.

FIG. 7A is a schematic diagram of alternative forms of shielding wall structures and a shutter according to the second embodiment of the present invention.

FIG. 7B is a schematic diagram of alternative forms of the shielding wall structures and the shutter according to the second embodiment of the present invention.

FIG. 8 is a schematic diagram of an X-ray imaging apparatus according to a third embodiment of the present invention.

FIG. 9 is a schematic diagram of an X-ray imaging apparatus according to a fourth embodiment of the present invention.

FIG. 10 illustrates a flowchart of operation, which the alignment operation control unit causes to perform.

### DESCRIPTION OF THE EMBODIMENTS

Embodiments according to the present invention will be described below with referent to the drawings. In the drawings, similar elements are denoted by similar reference numerals and redundant description thereof is omitted.

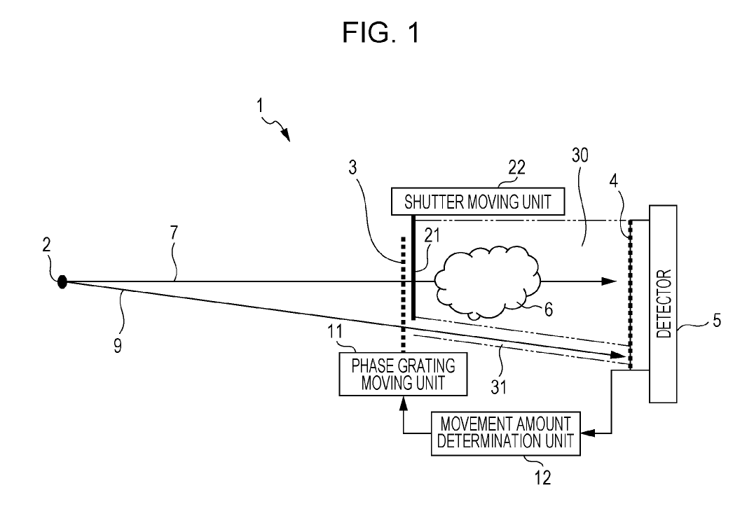

FIG. 1 is a schematic diagram of the structure of an X-ray imaging apparatus according to one exemplary embodiment. An X-ray imaging apparatus 1 illustrated in FIG. 1 includes an X-ray source 2, a phase diffraction grating (hereafter, referred to as a “phase grating”) 3, an amplitude diffraction grating (hereafter, referred to as a “shield grating”) 4, and a detector 5. The X-ray source 2 generates X-rays and the detector 5 detects X-rays. The X-ray imaging apparatus 1 also includes an adjustment mechanism and a shutter unit 20. The adjustment mechanism performs alignment and the shutter unit 20 adjusts an area to be irradiated with X-rays. The adjustment mechanism includes a movement amount determination unit 12 and a phase grating moving unit 11. The movement amount determination unit 12 is connected to the detector 5 and the phase grating moving unit 11 is connected to the phase grating 3. The shutter unit 20 includes a shutter 21 and a shutter moving unit 22. The shutter can be disposed between the X-ray source 2 and an object 6. The shutter moving unit 22 moves the shutter 21. The above-described components will be described below in more detail.

The X-ray imaging apparatus 1 according to the present embodiment includes the X-ray source 2 as a light source. The X-ray source 2 can use an X-ray source that emits continuous X-rays or an X-ray source that emits characteristic X-rays. An X-ray source grating that splits the X-rays into thin beams can be disposed in a path of X-rays emitted from the X-ray source 2. In this case, the X-ray source grating is considered as part of the X-ray source 2. Since an interference pattern needs to be formed by diffracting the X-rays emitted from the X-ray source 2 using the phase grating 3, which will be described below, a certain degree of spatial coherence with which the interference pattern can be formed is required.

An X-ray irradiation axis 7 is an axis passing through the center of an X-ray emitting unit of the X-ray source 2 and the center of the detector 5.

The X-rays emitted from the X-ray source 2 are diffracted by the phase grating 3 so as to form an interference pattern, in which bright portions and dark portions are periodically arranged. Herein, portions where the intensity of X-rays is high are referred to as bright portions and portions where the intensity of X-ray is small are referred to as dark portions.

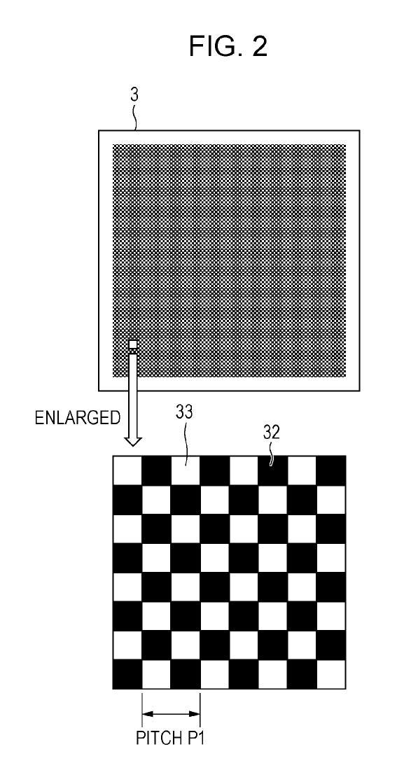

FIG. 2 illustrates a top view of the phase grating 3 according to the present embodiment and an enlarged view of part of the phase grating 3. The phase grating 3 has phase reference portions 32 and phase shift portions 33 arranged in a checkered grating. The phase reference portions 32 are spaced apart from one another by a pitch P1, and the phase shift portions 33 are spaced apart from one another by the pitch P1 in either of the two directions of the checkered grating. The phases of X-rays having been transmitted through the phase shift portions 33 are each shifted by a certain amount compared to those of X-rays having been transmitted through the phase reference portions 32. Although the amount by which the phase is shifted is generally π or π/2, the phase shift amount can be a value different from π or π/2; for example phase shift amount can be any fraction or multiply of π. In the present embodiment, the phase grating 3 is formed of silicon and has openings periodically formed therein. The phase shift portions 33 are formed of silicon and the phase reference portions 32 are defined by the openings devoid of any material. Alternatively, the phase reference portions 32 and the phase shift portions 33 can be formed by changing the thickness of the silicon material, can be formed of a material other than silicon as long as the material has a high X-ray transmittance, or these portions can be formed of two or more materials to form the phase grating 3. The structure of the phase grating 3 is not limited to the above description. The phase grating 3 can instead be, for example, formed by arranging the phase reference portions 32 and the phase shift portions 33 in a crosshatching shape. Although the diffraction grating can be an amplitude diffraction grating, the phase grating is more suitable because X-ray radiation loss is smaller with the phase grating.

During operation, while the X-rays having been diffracted by the phase grating 3 are being transmitted through the object 6, the phase thereof is changed in accordance with the refractive index and the shape of the object, thereby forming a self image at a position spaced away from the phase grating 3 by a certain distance, which is called a Talbot distance.

The shield grating 4 has a structure, in which shielding portions that shield the X-rays and transmitting portions that transmit the X-rays are periodically arranged, and is disposed at a position where the self image is formed. A Moire is formed by blocking part of the X-rays that form the self image, using the shield grating 4. The shielding portions are formed of a material having a low X-ray transmittance such as gold or lead, and the transmitting portions can be formed of a material having a high X-ray transmittance such as silicon, or can be defined by gaps free of material. The shielding portions do not necessarily completely block the X-rays. However, the shielding portions need to block the X-rays to such a degree as that the Moire can be formed by superposing the shield grating 4 on the interference pattern.

The detector 5 is a planar photodetector that senses X-rays, having pixels arranged at a pitch of not lower than several microns (μm) and not greater than a few hundred μm. The detector 5 detects the intensity distribution (Moire) of the X-rays having been transmitted through the shield grating 4.

A result of the detection, an electric signal is transmitted to a computer as a computing device, and through computation performed by the computer, images of the object 6 including a differential phase image, a phase image, a scattering image, and an absorption image can be obtained.

The adjustment mechanism that performs alignment includes the movement amount determination unit 12 and the phase grating moving unit 11. The movement amount determination unit 12 is connected to the detector 5 and the phase grating moving unit 11 is connected to the phase grating 3. The movement amount determination unit 12 determines a movement amount (including a direction of the movement) of the phase grating 3 in accordance with the intensity distribution (Moire) detected by the detector 5. The movement amount of the phase grating 3 is determined by a calculation performed by the movement amount determination unit 12. Through the calculation, in what direction and in what amount the phase grating 3 is to be moved in order to detect a desired Moire while the shield grating 4 is assumed to be fixed are calculated by comparing the desired Moire and an actually detected Moire. A determination result of a movement amount determined as described above is transmitted from the movement amount determination unit 12 to the phase grating moving unit 11.

Continuing to refer to FIG. 1, the phase grating moving unit 11 moves the phase grating 3 in accordance with the determination result transmitted from the movement amount determination unit 12, thereby changing the positions of the phase grating 3 and the shield grating 4 relative to each other. The changes in relative position cause the positions of the interference pattern and the shield grating 4 to change relative to each other, and accordingly, cause the Moire formed through the shield grating 4 to be changed.

Although the adjustment mechanism according to the present embodiment performs alignment by changing the positions of the phase grating 3 and the shield grating 4 relative to each other, the method of alignment is not limited to this. Alignment herein includes either or both of the following adjustments: adjustment of the positions of at least two of the X-ray source 2, the phase grating 3, the shield grating 4, and the detector 5 relative to each other; adjustment of the orientation of at least one of the X-ray source 2, the phase grating 3, the shield grating 4, and the detector 5. Herein, when the positions of at least two of the X-ray source 2, the phase grating 3, the shield grating 4, and the detector 5 have been moved relative to each other, it is regarded that the relative positions of the moved components have been adjusted. Also, when the orientation of at least one of the X-ray source 2, the phase grating 3, the shield grating 4, and the detector 5 has been changed, it is regarded that the orientation of the component with its orientation changed has been adjusted. Even when only one of the above-described adjustment of the relative positions and adjustment of the orientation has been performed, it is still considered that alignment has been performed. The orientation herein includes an angle (tilt) relative to a plane parallel to the X-ray irradiation axis 7 and a rotation angle along a plane perpendicular to the X-ray irradiation axis 7. In the case where the self image is directly detected by the detector 5 without use of the shield grating 4, alignment refers to either or both of the following adjustments: adjustment of the positions of at least two of the X-ray source 2, the phase grating 3, and the detector 5 relative to each other; an adjustment of the orientation of at least one of the X-ray source 2, the phase grating 3, and the detector 5. Also in this case, when the positions of at least two of the X-ray source 2, the phase grating 3, and the detector 5 have been moved relative to each other, it is regarded that the relative positions of the moved components have been adjusted, and when the orientation of at least one of the X-ray source 2, the phase grating 3, and the detector 5 has been changed, it is regarded that the orientation of the component with its orientation changed has been adjusted.

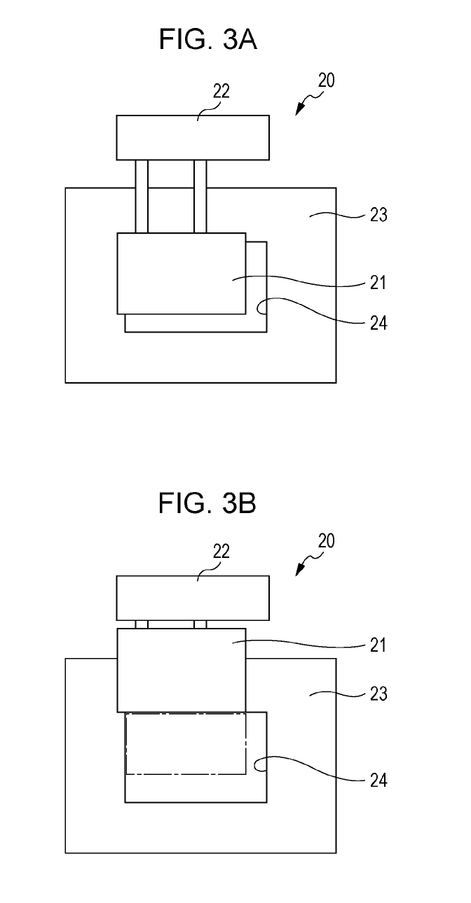

Referring now to FIGS. 3A and 3B, the structure and function of the shutter unit 20 are described. The shutter unit 20, which adjusts an area to be irradiated with X-rays, includes the shutter 21, the shutter moving unit 22, and a mask 23. The shutter can be disposed in a space between the X-ray source 2 and the object 6. The shutter moving unit 22 moves the shutter 21. The space between the X-ray source 2 and the object 6 refers to a space formed by connecting outer edges of an image-capturing area for the object 6 and the X-ray source 2. FIGS. 3A and 3B are schematic diagrams of the shutter unit 20 seen from the X-ray source 2.

The shutter 21 and the mask 23 are each formed of a material that blocks X-rays. For example, a metal having a low X-ray transmittance such as lead can be used. The shutter moving unit 22 can move the shutter 21.

By disposing the shutter 21 between the X-ray source 2 and the object 6, a first space 30 and a second space 31 are formed. Herein, the first space 30 is a space to be shielded by the shutter 21 from X-ray irradiation, and the second space 31 is a space not to be shielded by the shutter 21 from X-ray irradiation. The first space 30 and the second space 31 are spaces existing between the shutter 21 and the detector 5 in a direction in which the X-ray irradiation axis 7 extends. Without the shutter 21, both the first and second spaces 30 and 31 respectively are irradiated with the X-rays. Although the shutter 21 is disposed between the phase grating 3 and the object 6 in the present embodiment, the shutter 21 can be disposed at any position between the X-ray source 2 and the object 6. The shutter 21 is moved by the shutter moving unit 22. This causes the shutter 21 to be disposed between the X-ray source 2 and the object 6 or disposed at a position out of the space between the X-ray source 2 and the object 6. When the shutter 21 is disposed between the X-ray source 2 and the object 6, the shutter 21 is closed; when the shutter 21 is disposed at a position out of the space between the X-ray source 2 and the object 6, the shutter is opened. FIG. 3A illustrates a state in which the shutter 21 is closed, and FIG. 3B illustrates a state in which the shutter 21 is opened.

When the shutter 21 is closed as illustrated in FIG. 3A, the first space 30 is shielded from the X-rays by the shutter 21, and only the X-rays traveling through the second space 31 are incident upon the detector 5. Due to diffusion or scattering of the X-rays, part of the X-rays having traveled through the second space 31 can be incident upon the detector 5 through the first space 30. Such X-rays are also referred to as X-rays traveling through the second space 31. The movement amount determination unit 12 of the adjustment mechanism determines the movement direction and amount of the phase grating 3 in accordance with the intensity distribution (Moire) of the X-rays having traveled through the second space 31 and detected by the detector 5 when the shutter 21 is closed as described above. The movement amount determination unit 12 can determine the movement direction and amount of the phase grating 3 using whole or part of data of the Moire formed by the X-rays traveling through the second space 31 and detected by the detector 5.

When alignment is performed as described above, the object 6 is disposed in the first space 30. As described above, since the first space 30 is shielded from the X-rays, alignment can be performed while the object 6 is not irradiated with the X-rays.

When the shutter 21 is opened as illustrated in FIG. 3B, the object 6 is irradiated with the X-rays and an image of the object 6 can be captured.

When image-capturing time taken for image capturing is Tk, time required for alignment is Ta, and the amount of X-ray irradiation allowed in alignment relative to the amount of X-ray irradiation for image capturing is K, a shield factor S required for a shutter plate is given by the following equation:

S=K(Tk/Ta).

In the case where the amount of X-ray irradiation allowed for the object 6 in alignment is 1% of the amount of X-ray irradiation for the object 6 in image capturing, K=1%. For example, X-ray irradiation time in image capturing is 1 second, X-ray irradiation time in alignment is 10 minutes, the shield factor S required for the shutter 21 calculated from the above-described expression is 1/100(1/600)=0.6E−3. Since the X-ray shield factor of a lead having a thickness of 0.5 mm is 1.0E−15, a sufficient X-ray shielding effect can be obtained when the shutter 21 is formed of a lead having a thickness of 0.5 mm.

When alignment is performed with the object 6 placed within the image-capturing area, a deviation in alignment occurring during or after placement of the object 6 can be corrected. As an example of deviations in alignment occurring during or after placement of the object 6, a deviation in alignment due to temperature changes will be described.

In general, an X-ray phase imaging apparatus is affected by temperature changes depending on time taken for image capturing and the season. For example, when the size of the phase grating 3 is 1, the linear thermal expansion coefficient of the phase grating 3 is α, and a temperature change is δt, the amount of deformation ΔL of the phase grating 3 due to heat is given by the following equation:

ΔL=1×α×δt.

Here, when the size of the phase grating 3 is 250 mm, the linear thermal expansion coefficient of the phase grating 3 formed of silicon is 2.55×10⁻⁶(1/k), and the temperature change is 5° C., ΔL is calculated as follows:

ΔL=250×2.55×10⁻⁶×5=3 μm.

Thus, when the temperature is changed by 5° C., the amount of deformation ΔL of the phase grating 3 due to heat is 3 μm.

When the phase shift amount of the phase grating 3 is π/2, the amount of deformation of the interference pattern is also about 3 μm.

When this amount of deformation of the interference pattern is greater than a half of the pitch of the shield grating 4, a situation occurs, in which information about part of the object 6 is difficult to obtain.

Next, a cause of a change in environmental temperature will be described. In general, in order to prevent changes in optical systems from occurring, the temperature of the environment in which an X-ray imaging apparatus is located is maintained at a certain range of temperatures, which is typically 25° C. or lower. However, when the object 6 is a human body, of which the body temperature is about 36° C., there is a possibility of a change in temperature of the phase grating 3 by 5° C. or greater due to placement of the object 6 within the image-capturing area. In contrast, the shield grating 4 is disposed at a position further away from the object 6 than the phase grating 3 is, and accordingly, not easily affected by the body temperature of the object 6. Thus, the position of each bright portions of the interference pattern and the position of a corresponding one of the shielding portions of the shield grating 4 change relative to each other, thereby making accurate image capturing difficult.

As described above, when the object 6 is placed within the image-capturing area of the X-ray imaging apparatus 1, the object 6 being an object such as, for example, a human body having a temperature different from the environmental temperature to which the X-ray imaging apparatus 1 has been exposed before the object 6 is placed, the amount of deformation due to temperature changes is greater in the phase grating 3 in a single X-ray imaging apparatus 1. In the present embodiment, alignment is performed immediately before performing image capturing with the object 6 placed within the image-capturing area, thereby decreasing effects of the deviation in alignment due to temperature changes. A deviation in alignment refers to deviations of the positions of at least two of the X-ray source 2, the phase grating 3, the shield grating 4, and the detector 5 relative to each other, and a deviation of the orientation of at least one of the X-ray source 2, the phase grating 3, the shield grating 4, and the detector 5.

As is the case with the shutter 21, the mask 23 is formed of a material that blocks X-rays and has an opening 24. The mask 23 is secured to the X-ray imaging apparatus 1 and prevents an area that does not need to be irradiated with the X-rays from being irradiated with the X-rays. The area that does not need to be irradiated with the X-rays refers to an area that is neither the image-capturing area nor an area needs to be irradiated with the X-rays for alignment. As is the case with the shutter 21, a sufficient shielding effect can be obtained when the mask 23 is formed of a lead having a thickness of 0.5 mm. The structure of the mask 23 is not limited to the structure illustrated in FIGS. 3A and 3B. For example, the mask 23 can be separated from the shutter unit 20 and disposed at a position upstream of the shutter unit 20, or can be disposed in the X-ray emitting unit of the X-ray source 2. When there is no such an area as that does not need to be irradiated with the X-rays, the mask 23 can be omitted.

Operation of the X-ray imaging apparatus 1 in alignment and in capturing an image of the object 6 capturing will be described. Alignment is performed before capturing an image of the object 6.

As has been described, alignment is performed on the X-ray imaging apparatus 1 according to the present embodiment with the shutter 21 closed as illustrated in FIG. 3A. By doing this, the X-rays with which the object 6 is irradiated during alignment can be almost blocked.

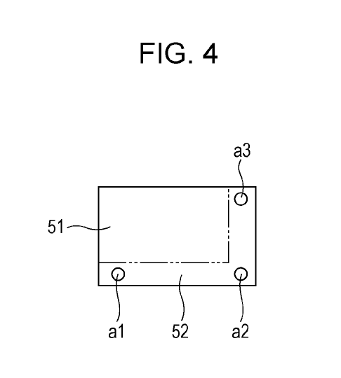

The position of the phase grating 3 is adjusted as described above in accordance with the intensity distribution of the X-rays detected by the detector 5. FIG. 4 is a schematic diagram of the detector 5 seen from the X-ray source 2 side. A region separated by two-dot chain lines at the top left portion in FIG. 4 is a first-space-contacting region 51, which is in contact with the first space 30. The first-space-contacting region 51 is to be irradiated with the X-rays in order to capture the image of the object 6 and corresponds to the image-capturing area of the X-ray imaging apparatus 1. A region on the right and below the first-space-contacting region 51 is a second-space-contacting region 52, which is in contact with the second space 31. The second-space-contacting region 52 is to be irradiated with the X-rays in order to perform alignment. The regions in FIG. 4 refer to specific areas on a detection surface of the detector 5. When the shutter 21 is opened, the X-rays are incident upon the first-space-contacting region 51 and the second-space-contacting region 52. In contrast, when the shutter 21 is closed, although in some cases the X-rays having traveled through the second space 31 can be incident upon the first-space-contacting region 51 of the detection surface due to diffusion or scattering of the X-rays, the X-rays are mainly incident upon the second-space-contacting region 52.

Only a portion of the second-space-contacting region 52 is actually used for alignment. The portion of the second-space-contacting region 52 used for the alignment can be provided in a plurality. In the present embodiment, alignment is performed in accordance with the intensity distribution of the X-rays detected in portions a1, a2, and a3 in FIG. 4. In the case where the second space 31 is formed as in the present embodiment, the alignment can be performed using three end portions out of top, bottom, left, and right end portions of the rectangular detection surface. The reason is that, when the movement amount and direction of the phase grating 3 are determined in accordance with the intensity distribution of the X-rays detected at positions spaced away from each other as further as possible, accuracy with which the movement amount and direction of the phase grating 3 are calculated can become higher. Furthermore, by moving the object 6 into or out of the image-capturing area through one of the four corners at the top, bottom, left and right of the detection surface, the one corner not including the portion used for the alignment (the top left corner in FIG. 4), the object 6 can be moved into or out of the image-capturing area without being irradiated with the X-rays while the X-rays for alignment 9 are being emitted.

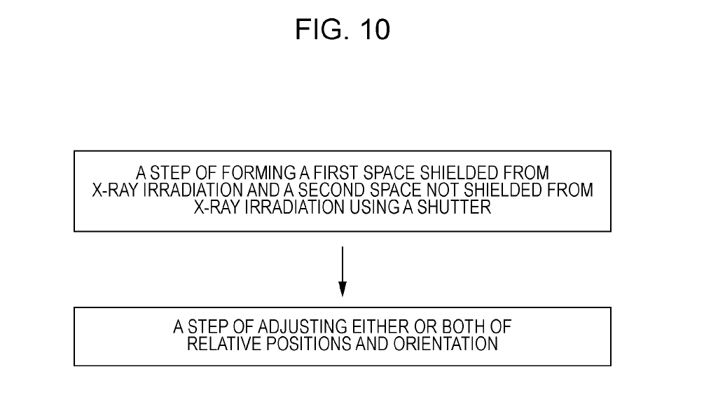

The above-described alignment operation can be performed by manually operating the shutter unit 20, the X-ray source 2, the detector 5, and a movement amount adjustment mechanism, or can be performed by an alignment operation control unit (not shown). For example, the alignment operation control unit issues commands to the shutter unit 20, the X-ray source 2, the detector 5, and the movement amount adjustment mechanism, thereby causing the above-described alignment operation to be performed. The alignment operation control unit includes, for example, a computer in which a program that causes the above-described alignment operation to be performed is installed. FIG. 10 illustrates a flowchart of operation, which the alignment operation control unit causes to perform. When alignment is completed, an image of the object 6 is captured.

The shutter 21 is opened at timing of image capturing, so that the object 6 is irradiated with the X-rays. Furthermore, as is the case with the present embodiment, in the case where the X-rays having traveled through the second space 31 during image capturing are incident upon the detector 5, alignment can be also performed during image capturing. By performing alignment in accordance with the intensity distribution of the X-rays incident upon the second-space-contacting region 52 while detecting the intensity distribution of the X-rays incident upon the first-space-contacting region 51, deviations in alignment occurring during image capturing can be corrected. Thus, by performing alignment during image capturing, an image of the object 6 can be captured with smaller deviations in alignment. Causes of deviations in alignment occurring during image capturing includes, in addition to changes in environmental temperature due to the temperature of the object 6 as described above, movements of the X-ray source 2, the phase grating 3, the shield grating 4, and the detector 5 during image capturing. The position of the self image and the position of the shield grating 4 relative to each other are moved in a phase shift method (a fringe scanning method), and images of the object 6 are captured at a variety of angles in tomography. Thus, in general, one or more of the X-ray source 2, the phase grating 3, the shield grating 4, and the detector 5 is moved during image capturing. When alignment is performed during image capturing, deviations in alignment occurring due to movements of these components can be corrected. Furthermore, in a phase shift method, tomography, or the like, when image capturing is performed a plurality of times while the object 6 is placed, alignment can be performed with the shutter 21 closed between image capturing operations. By closing the shutter 21 during alignment, the object 6 can be prevented from being irradiated with the X-rays for alignment. After image capturing is completed, in order to prevent the first space 30 from being irradiated with the X-rays due to accidental failure or the like, the shutter 21 can be closed.

The method of capturing an X-ray phase contrast image of the object 6 according to the present embodiment has been described.

Although the object 6 is placed between the phase grating 3 and the shield grating 4 in the present embodiment, the object 6 can be placed between the X-ray source 2 and the phase grating 3. In this case, by disposing the shutter unit 20 between the X-ray source 2 and the object 6, advantages similar to those obtained in the present embodiment can be obtained.

Although X-rays not used for capturing an image of the object 6 or for alignment is blocked by the mask 23 of the shutter unit 20 in the present embodiment, the mask 23 can be disposed between the X-ray source 2 and the shutter 21 or on the X-ray source grating.

### Second Embodiment

The difference between a second embodiment and the first embodiment is that, in the second embodiment, in order to prevent the X-rays from leaking to the first space 30, a wall that blocks the X-rays (shielding wall structure) is provided between the shutter 21 and the detector 5.

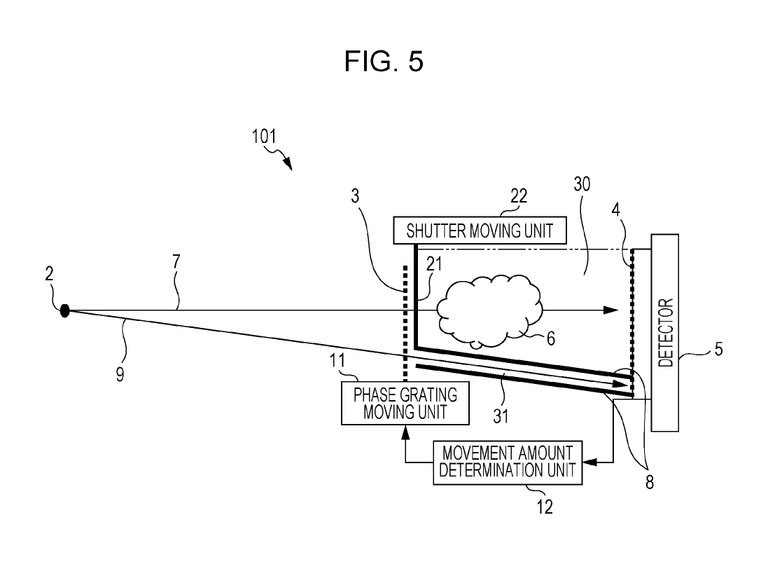

FIG. 5 is a schematic diagram of the structure of an X-ray imaging apparatus 101 according to the present embodiment. Since the structures of the X-ray source 2, which emits X-rays, the phase grating 3, the shield grating 4, the detector 5, which detects the X-rays, the adjustment mechanism for performing alignment, and the shutter unit 20 are the same as those of the first embodiment, description thereof is omitted. The X-ray imaging apparatus 101 includes a shielding wall structure 8, which blocks the X-rays, between the shutter 21 and the detector 5. The shielding wall structure 8 is formed of a material that blocks X-rays. For example, when, as is the case with the shutter 21, a lead having a thickness of 0.5 mm is used, a sufficient shielding effect can be obtained. The shielding wall structure 8 is disposed in the first space 30 or at the boundary between the first space 30 and the second space 31, thereby decreasing the amount of X-ray radiation leaking from the second space 31 to the first space 30 when the shutter 21 is closed.

In order to effectively decrease the amount of the X-ray leaking to the first space 30, the shielding wall structure 8 can be provided so as to connect the shutter 21 to the detector 5. However, even with the shielding wall structure 8 provided in part of the space between the shutter 21 and the detector 5, the amount of the X-ray leaking to the first space 30 can be decreased.

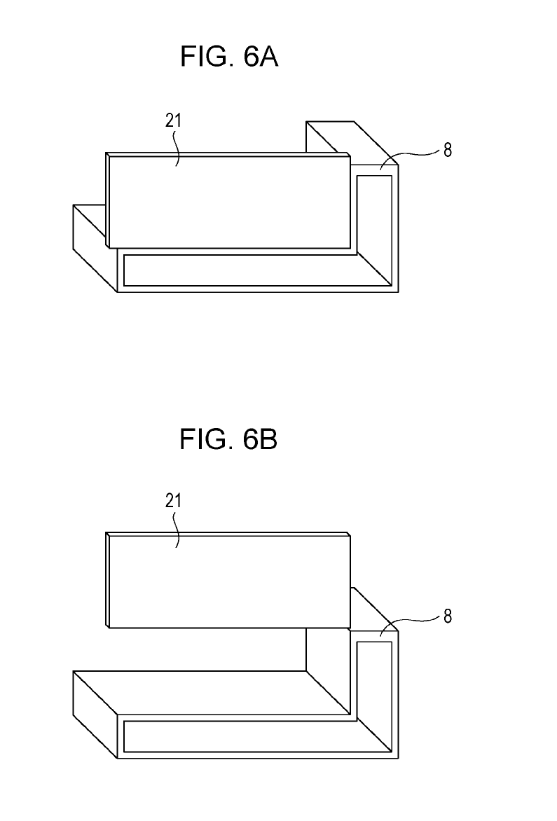

FIGS. 6A and 6B are schematic diagrams of the shutter 21 and the shielding wall structure 8 according to the second embodiment of the present invention seen from the X-ray source 2 side. The shielding wall structure 8 illustrated in FIGS. 6A and 6B is disposed at the boundary between the first space 30 and the second space 31.

FIG. 6A illustrates a state in which the shutter 21 is closed, and FIG. 6B illustrates a state in which the shutter 21 is opened. The shutter moving unit 22 and the mask 23 illustrated in FIGS. 3A and 3B are omitted from FIGS. 6A and 6B. In FIG. 6A, the shutter 21 is closed, and accordingly, the object 6 is shielded from the X-rays by the shutter 21. Since the X-rays used for alignment travel through a space surrounded by the shielding wall structure 8 and then are incident upon the detector 5, alignment can be performed even when the shutter 21 is closed.

The shielding wall structure 8 blocks the X-rays so as to prevent the X-rays for alignment from leaking to the first space 30. In addition, the shielding wall structure 8 prevents the object 6 from entering the second space 31.

In the X-ray imaging apparatus 1 according to the first embodiment, there is a possibility of leakage of diffused or scattered X-rays from the second space 31 to the first space 30 during alignment, thereby causing the object 6 to be irradiated with the X-rays for alignment. This situation can be prevented by the X-ray imaging apparatus 101 according to the present embodiment. Furthermore, the X-ray imaging apparatus 101 according to the present embodiment can also prevent the object 6 from accidentally entering the second space 31 during alignment.

In the X-ray imaging apparatus 101 according to the present embodiment, the X-rays, which pass through a portion below the shutter 21 as the X-rays for alignment during alignment, pass through the space surrounded by the shielding wall structure 8 also when the shutter 21 is opened. This can prevents the object 6 from being irradiated with the X-rays for alignment also when an image of the object 6 is captured.

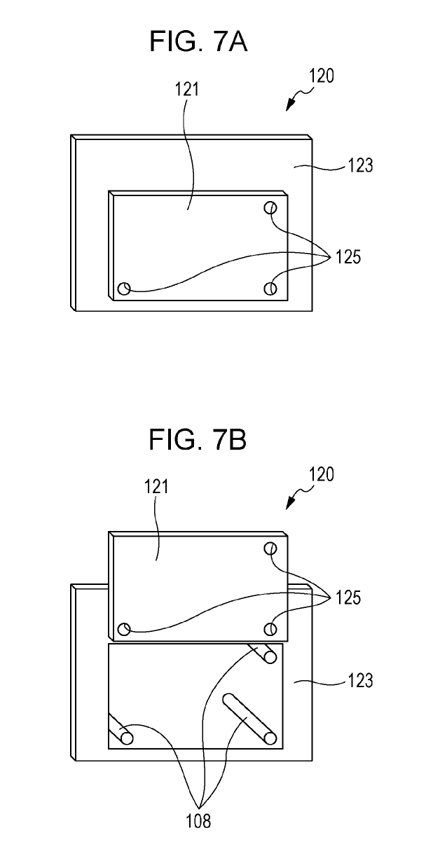

FIGS. 7A and 7B illustrate schematic diagrams of alternative forms of shielding wall structures and a shutter. FIG. 7A illustrates a state in which the shutter is closed, and FIG. 7B illustrates a state in which the shutter is opened. Referring to FIG. 7A, a shutter unit 120 includes a shutter 121, a shutter moving unit (not shown), and a mask 123. The shutter 121 has three circular openings 125 corresponding to portions of the detector 5 where alignment is performed. The openings 125 are formed at positions corresponding to the a1, a2, and a3 in FIG. 4, so that, when the shutter 121 is closed, the X-rays for alignment are incident upon the detector 5. Furthermore, as illustrated in FIG. 7B, cylindrical shielding wall structures 108 are provided corresponding to respective openings 125. The shielding wall structures 108 each extend from the shutter 121 to the detector 5.

In the case where the shutter 121 has the above-described structure, the first space 30 is shielded from X-ray irradiation by the shutter 121. Accordingly, when the shutter 121 is closed, a contact surface where the first space 30 and the shutter 121 are in contact with each other is part of the shutter 121 where the openings 125 are not formed. When the shutter 121 is closed, it can be said that the second space 31 and the shutter 121 are in contact with each other in the openings 125. In the case illustrated in FIGS. 7A and 7B, the X-ray imaging apparatus 101 has three second spaces 31.

When the shielding wall structures 108 are structured as described above, the shielding wall structures 108 prevent the X-rays having passed through the openings 125 from leaking to the first space 30. Alignment is performed using the X-rays traveling through cylindrical spaces surrounded by the shielding wall structures 108.

Referring to FIGS. 7A and 7B, the diameter of each shielding wall structure 108 on the surface in contact with the shutter 121 is larger than the diameter of a corresponding one of the openings 125 formed in the shutter 121. That is, the shielding wall structures 108 are formed not at the boundary between the first space 30 and the second space 31, but in the first space 30. With the shielding wall structures 108 formed as above, the spaces surrounded by the shielding wall structures 108 each include not only the second space 31 formed by the shutter 121, but also part of the first space 30.

Since operation of the X-ray imaging apparatus 101 according to the present embodiment during alignment and during capturing an image of the object 6 is similar to that of the X-ray imaging apparatus 1 according to the first embodiment, description thereof is omitted.

### Third Embodiment

The difference between a third embodiment and the first embodiment is that, in the third embodiment, in order to block the X-rays for alignment 9 after alignment is completed, the X-rays for alignment 9 being X-rays with which the second space 31 is irradiated, an X-ray shutter for alignment is provided.

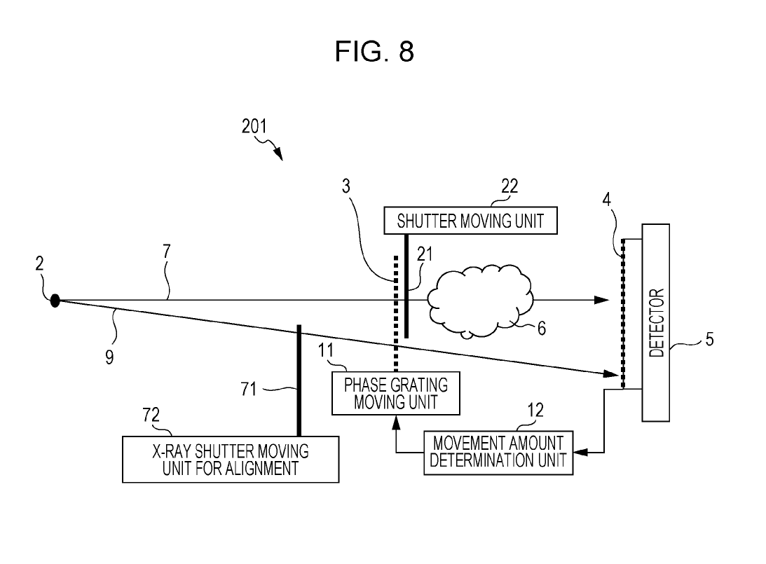

FIG. 8 is a schematic diagram of the structure of an X-ray imaging apparatus 201 according to the present embodiment. The X-ray source 2, the phase grating 3, the shield grating 4, the detector 5, the adjustment mechanism, and the shutter unit 20 are the same as those of the first embodiment and the description thereof is omitted. A component specific to the present embodiment is an X-ray shutter unit for alignment. The X-ray shutter unit for alignment includes an X-ray shutter for alignment 71 and an X-ray shutter moving unit for alignment 72. The X-ray shutter moving unit for alignment 72 moves the X-ray shutter for alignment 71, thereby opening and closing the X-ray shutter for alignment 71.

The X-ray shutter for alignment 71 in an open state is disposed out of the area irradiated with the X-rays, and the second space 31 is irradiated with the X-rays. The X-ray shutter for alignment 71 in a closed state is disposed so as to shield the whole area not shielded by the mask 23 and the shutter 21, which shield the first space 30, thereby shielding the second space 31 from the X-rays.

Description of operation of the X-ray imaging apparatus 201 according to the present embodiment during alignment is omitted because it is similar to that of the X-ray imaging apparatus 1 according to the first embodiment except for that the second space 31 is irradiated with the X-rays by opening the X-ray shutter for alignment 71 during alignment.

As is the case with the X-ray imaging apparatus 1 according to the first embodiment, the X-ray imaging apparatus 201 captures an image of the object 6 after alignment is completed. In order to perform image capturing, the shutter 21 that shields the first space 30 is opened, so that the object 6 is irradiated with the X-rays. In so doing, the X-ray shutter for alignment 71 is closed so as to block the X-rays with which the second space 31 is irradiated. By doing this, the object 6 is prevented from being irradiated with the X-rays for alignment 9 and scattered X-rays thereof during image capturing. However, when the X-ray shutter for alignment 71 is closed during image capturing, alignment cannot be performed during image capturing. Thus, the X-ray shutter for alignment 71 can be opened only when alignment is performed while capturing an image of the object 6.

### Fourth Embodiment

The difference between a fourth embodiment and the first embodiment is that, in the fourth embodiment, when the object 6 has entered the second space 31, X-ray irradiation from the X-ray source 2 is stopped.

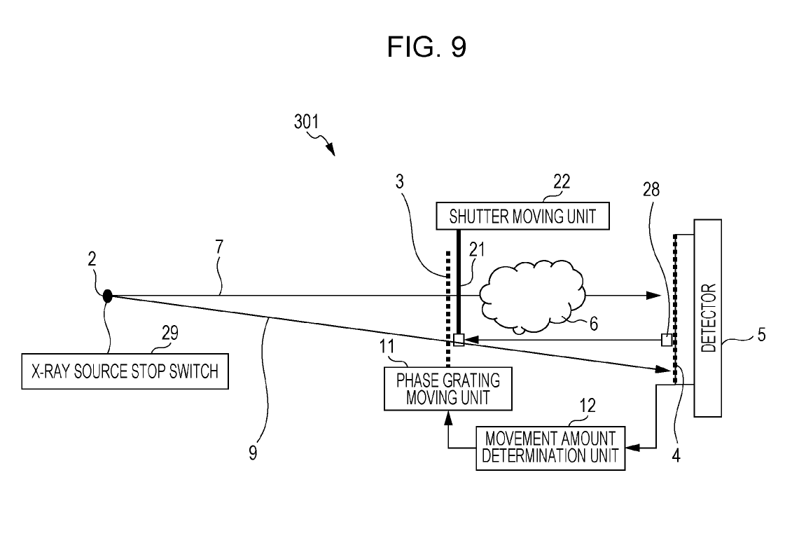

FIG. 9 is a schematic diagram of the structure of an X-ray imaging apparatus 301 according to the present embodiment. The X-ray source 2, the phase grating 3, the shield grating 4, the detector 5, the adjustment mechanism, and the shutter unit 20 are the same as those of the first embodiment and the description thereof is omitted. As components specific to the present embodiment, the X-ray imaging apparatus 301 includes an object sensor 28 and an X-ray source stop switch 29. The object sensor 28 detects that the object 6 has entered the second space 31. The X-ray source stop switch 29 can cause the X-ray source 2 to stop X-ray irradiation.

The object sensor 28 detects that the object 6 has entered the second space 31. The object sensor 28 can include, for example, a photoelectric line sensor. In FIG. 9, it may appear that the object sensor 28 is provided within the image-capturing area. However, when the object 6 is larger than the image-capturing area, the object 6 can be provided at a desired position at the top, bottom, left, and right of the image-capturing area. By doing this, the object sensor 28 can detect entrance of the object 6 without interfering with image capturing.

In the case where the X-rays are emitted from the X-ray source 2, the shutter 21 is closed, and the second space 31 is irradiated with the X-rays for alignment 9, when the object 6 enters the second space 31, the object sensor 28 detects entrance of the object 6 and transmits to the X-ray source stop switch 29 the detection of entrance of the object 6.

Upon reception of a signal indicating entrance of the object 6 from the object sensor 28, the X-ray source stop switch 29 causes the X-ray source 2 to stop X-ray irradiation. Thus, the object 6 can be prevented from being irradiated with the X-rays in the second space 31.

Description of operation of the X-ray imaging apparatus 301 according to the present embodiment during alignment and during capturing of an image of the object 6 is omitted because it is similar to that of the X-ray imaging apparatus 1 according to the first embodiment, except for that, when the object 6 enters the second space 31 during alignment, X-ray irradiation from the X-ray source 2 is stopped.

X-ray irradiation can be stopped when the object sensor 28 detects that the object 6 has entered the second space 31 also when the shutter 21 is opened. Furthermore, X-ray irradiation can be prevented even if an operation to perform alignment is performed while the object 6 exists in the second space 31. Instead of causing the X-ray source 2 to stop X-ray irradiation, the X-ray source stop switch 29 can utilize a mask that can block the X-rays so as to stop irradiation of the second space 31 with the X-rays.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., non-transitory computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-212968 filed Sep. 28, 2011, which is hereby incorporated by reference herein in its entirety.

What is claimed is:

1. An X-ray imaging apparatus comprising:
a diffraction grating that diffracts an X-ray from an X-ray source so as to form an interference pattern having a bright portion and a dark portion arranged in the interference pattern;
a detector that detects the X-ray having passed through the diffraction grating;
a shutter configured to be removably disposed between the X-ray source and an object to temporarily block the X-ray from the X-ray source; and
an adjustment mechanism configured to adjust either or both of positions of at least two of the X-ray source, the diffraction grating and the detector relative to each other, and an orientation of at least one of the X-ray source, the diffraction grating and the detector with respect to an irradiation axis,
wherein, when the shutter is disposed between the X-ray source and the object, the shutter defines a first space shielded from irradiation by the X-ray from the X-ray source, and a second space not shielded from the irradiation, and
wherein the adjustment mechanism adjusts either or both of the positions and the orientation in accordance with at least part of an intensity distribution of the X-ray having traveled through the second space and being detected by the detector.

2. The X-ray imaging apparatus according to claim 1,
wherein a plurality of the second spaces are formed.

3. The X-ray imaging apparatus according to claim 1, further comprising:
a wall disposed at least part of a space between the shutter and the detector, the wall blocking the X-ray, the wall being disposed in the first space or at a boundary between the first space and the second space.

4. The X-ray imaging apparatus according to claim 1, further comprising:
an object sensor that detects a position of the object,
wherein, when the object sensor detects that the object has entered the second space while the first space is shielded from the irradiation using the shutter, the X-ray source is made to stop irradiating the second space with the X-ray.

5. An X-ray imaging apparatus comprising:
a diffraction grating that diffracts an X-ray from an X-ray source so as to form an interference pattern having a bright portion and a dark portion arranged in the interference pattern;
a shield grating that has a shielding portion blocking the X-ray and a transmitting portion allowing the X-ray to transmit therethrough, the shield grating blocking part of the X-ray that forms the interference pattern;
a detector that detects the X-ray having passed through the shield grating;
a shutter configured to be removably disposed between the X-ray source and an object to temporarily block the X-ray from the X-ray source; and
an adjustment mechanism configured to adjust either or both of positions of at least two of the X-ray source, the diffraction grating, the shield grating and the detector relative to each other, and an orientation of at least one of the X-ray source, the diffraction grating, the shield grating and the detector with respect to an irradiation axis,
wherein, when the shutter is disposed between the X-ray source and the object, the shutter defines a first space shielded from irradiation by the X-ray from the X-ray source, and a second space not shielded from the irradiation, and
wherein the adjustment mechanism adjusts either or both of the positions and the orientation in accordance with at least part of an intensity distribution of the X-ray having traveled through the second space and being detected by the detector.

6. The X-ray imaging apparatus according to claim 5,
wherein a plurality of the second spaces are formed.

7. The X-ray imaging apparatus according to claim 5, further comprising:
a wall disposed at least part of a space between the shutter and the detector, the wall blocking the X-ray, the wall being disposed in the first space or at a boundary between the first space and the second space.

8. The X-ray imaging apparatus according to claim 5, further comprising:
an object sensor that detects a position of the object,
wherein, when the object sensor detects that the object has entered the second space while the first space is shielded from the irradiation using the shutter, the X-ray source is made to stop irradiating the second space with the X-ray.

9. The X-ray imaging apparatus according to claim 5,
wherein the first space and the second space are formed between the shutter and the detector in a direction in which the radiation travels from the X-ray source to the detector.

10. The X-ray imaging apparatus according to claim 5,
wherein the adjustment mechanism adjusts said either or both of the positions and the orientation while the object is not irradiated with the radiation from the X-ray source.

11. The X-ray imaging apparatus according to claim 5,
wherein an object is placed in the first space, and
wherein, when the shutter is not disposed between the X-ray source and the detector, an image of the object is captured by the detector.

12. A non-transitory computer readable medium storing a computer program for controlling an X-ray imaging apparatus that captures an image of an object placed between an X-ray source and a diffraction grating or between the diffraction grating and a detector, the computer program being executed on a computer so that the computer causes the X-ray imaging apparatus to perform steps of:
forming a first space shielded from irradiation by the X-ray from the X-ray source and a second space not shielded from the irradiation using a shutter, the shutter being configured to be removably disposed between the X-ray source and the object to temporarily block the X-ray from the X-ray source; and
adjusting either or both of positions of at least two of the X-ray source, the diffraction grating and the detector relative to each other, and an orientation of at least one of the X-ray source, the diffraction grating and the detector with respect to an irradiation axis in accordance with at least part of an intensity distribution of the X-ray having traveled through the second space and being detected by the detector.

13. The non-transitory computer readable medium according to claim 12,
wherein the computer program controls an X-ray imaging apparatus including a shield grating that shields part of the X-ray of an interference pattern formed by the diffraction grating, and
wherein, the step of adjusting either or both of the positions and the orientation adjusts either or both of the position of at least one of the X-ray source, the diffraction grating and the detector and a position of the shield grating relative to each other, and an orientation of the shield grating with respect to the irradiation axis.

14. A method of capturing images with an X-ray imaging apparatus that captures an image of an object placed between an X-ray source and a diffraction grating or between the diffraction grating and a detector, the method comprising;
forming a first space shielded from irradiation by the X-ray from the X-ray source and a second space not shielded from the irradiation using a shutter, the shutter being configured to be removably disposed between the X-ray source and the object to temporarily block the X-ray from the X-ray source;
placing the object in the first space; and
adjusting either or both of positions of at least two of the X-ray source, the diffraction grating and the detector relative to each other, and an orientation of at least one of the X-ray source, the diffraction grating and the detector with respect to an irradiation axis in accordance with at least part of an intensity distribution of the X-ray having traveled through the second space and being detected by the detector.

15. The method of capturing images according to claim 14,
wherein the method is used for an X-ray imaging apparatus including a shield grating that shields part of the X-ray of an interference pattern formed by the diffraction grating, and
wherein, the step of adjusting either or both of the positions and the orientation adjusts either or both of the position of at least one of the X-ray source, the diffraction grating and the detector and a position of the shield grating relative to each other, and an orientation of the shield grating with respect to the irradiation axis.
